(19) United States
(12) Patent Application Publication
(10) Pub. No.: US 2008/0059292 A1
(43) Pub. Date: Mar. 6, 2008

(54) SYSTEMS AND METHODS RELATED TO CONTINUOUS PERFORMANCE IMPROVEMENT

(76) Inventors: Lloyd N. MYERS, Pittsburgh, PA (US); Simone F. Karp, Pittsburgh, PA (US); Andrew L. Rabin, Pittsburgh, PA (US)

Correspondence Address: REED SMITH LLP, P.O. BOX 488, PITTSBURGH, PA, 15230-0488, US

(21) Appl. No.: 11/845,286

(22) Filed: Aug. 27, 2007

Related U.S. Application Data
(60) Provisional application No. 60/840,906, filed on Aug. 29, 2006.

(51) Int. Cl. G06F 17/30; G06F 17/40

(52) U.S. Cl. 705/11

(57) ABSTRACT

Systems and methods for the continuous improvement of performance. The present systems and methods provide the art with a mechanism for the continuous assessment of the performance of users. By measuring professional performance against benchmarks, standards, and goals, the present invention allows the art to assess continuously and in real time any gaps or deficiencies in performance of the user. The present invention also preferably provides users with performance improvement pathways that are targeted to address the deficiencies and shortcomings of each individual user. The present invention further provides a mechanism by which users may routinely evaluate their own performance and compare it against industry standards and peer groups. Through the present invention, users may also track activities related to their certification, licensure, or credentials and tie those to particular performance improvement pathways. The present invention is particularly useful within medical, legal, engineering, law enforcement, and public safety sectors.

### CROSS-REFERENCE TO RELATED APPLICATION

This application claims the benefit under 35 U.S.C. § 119(e) of the earlier filing date of U.S. Provisional Application Ser. No. 60/840,906 filed on Aug. 29, 2006, which is hereby incorporated by reference.

### BACKGROUND OF THE INVENTION

1. Field of the Invention

The present invention relates generally to systems and methods for continuous quality and performance assessment and improvement, and, more particularly, the present invention is directed to computerized and automated systems and methods for quality and performance improvement in the healthcare field.

2. Description of the Background

One of the challenges associated with any educational or professional business endeavor is the achievement of high performance to standards for an individual or across a population of learners or professional workforce. Quite often a gap or complete disconnect exists between measures of quality or performance and steps that are to be taken by the learner or their organization to improve performance. Currently in the prior art, there is no structured practice that provides learners with a framework within which performance can be continuously measured, analyzed and linked to developmental pathways designed to effectively improve performance, in an automated, individualized workflow fashion.

One arena where such disconnects are commonly encountered is the healthcare industry. Healthcare practitioners have at their disposal a wide variety of tools and content that are designed to educate and improve performance, e.g. continuing medical education (CME), lectures, classes, evidence-based guidelines, and various professional accreditations. Nevertheless, the service provided by practitioners varies widely even within individual organizations. Indeed, a 2001 Institute of Medicine report described the quality gap in the United States as a “chasm” and found that patients do not always receive care based on the best scientific knowledge available, and that problems of quality of care that affect the lives of patients are encountered routinely.

A great deal of the blame related to the healthcare “quality” crisis was placed upon professional and education organizations who are viewed as being responsible for ensuring the competency of the healthcare professional and the quality and safety of patient care. The methods, form, and scope of the post-graduate educational process in place today were called into question. In particular, continuing medical education was addressed and criticized, and the limited scope of focus related to ongoing performance, competency, certification, and licensure was attacked.

In essence, the 2001 report found that physicians had relied upon the current post-graduate continuing medical education system for the past four decades to keep abreast of rapidly changing medical knowledge, including emerging skills and techniques, and to enable them to practice in the most competent manner possible. While the CME system was found to foster the dissemination of medical knowledge, it could not and did not effectively keep up with the ever-changing landscape of medical knowledge, and has been shown to be ineffective as one-off activities. Further, it was found to be wholly inadequate for dealing with the increased emphasis on physician accountability with respect to patient safety, performance, cost and quality of care. New and improved techniques and systems are presently needed to deal with the changing landscape of medical knowledge and the dynamic system in which physicians practice.

A committee, which was comprised of numerous professional and educational organizations, issued recommendations to change the current system for certification, licensing and credentialing, in order to broaden the focus of provider learning towards a continuous lifetime process. This lifetime process intended to shift the emphasis from basic provider (i.e., physician) knowledge to a more comprehensive provider system in which competency and performance could be demonstrated to have a positive impact on patient outcomes and quality of care. The current system focused around CME programs was determined to be simply an intervention to improve knowledge, and new activities such as self-assessment, measure of competency, maintenance of certification, measures of quality and performance, and performance improvement were recommended to be included in the lifetime learning process.

During the same period of time, healthcare payers (including health plans, managed care organizations, and the U.S. government) were also being influenced by the Institute of Medicine report as well as the ever-rising cost of healthcare. These healthcare payers instituted programs that sought to shift the payment provided to healthcare professionals for services from being 100% fee-based (e.g., Dr. Smith performs a procedure and therefore receives $1,000 to pay for it) towards a system that would more appropriately reward providers based upon the timely and appropriate care that results in improved quality, patient care and outcomes. These programs utilize measures of quality to determine whether providers meet standards as set by the organizations setting such a requirement. Additional payment, preferred status, or some other type of incentive for achieving above standard performance would often be given only to the provider able to meet the goals, creating the “haves” and the “have nots”. These systems also necessitated new and improved systems and methods related to connecting the underachievers with a lifetime learning roadmap for improvement,

To date, the fields of quality and education in healthcare have operated independently. This phenomenon is evidenced by the division of such departments in academic medical centers, health systems and hospitals, medical associations, specialty societies and the like. The quality measurement programs that are in existence today are often comprised of very expensive and labor intensive manual aggregation and calculation of data manual chart abstraction. Providers are often sent their quality “scorecard” reports via administrative claims channels. Currently, there are no technology platforms or solutions that appropriately bridge and interlink continuous quality and performance measurement with medical education, let alone ongoing measurement, tracking of outcomes, and the automation of prescriptive pathways designed to enable personalized performance improvement by reversing the performance improvement process; educating to close the gaps exposed through measurement vs. educating for the sake of checking the educational requirement box.

Present systems that address these limitations of the prior art are wholly inadequate. On the education side of the ledger, there exist web-based solutions that support the delivery and tracking of online CME, but these platforms present volumes of unstructured content, are limited in focus, and do not support quality measurement, improvement pathways, or continuous structured lifetime learning. The nature of performance improvement is cyclical and longitudinal and an adequate system must support both. In contrast, today's educational platforms present activities (e.g., CME) that are typically designed as one-off projects to meet a generalized learning need. Such single, limited educational activities (e.g., CME) have been demonstrated to be ineffective at improving practitioner behavior and performance.

On the quality side of the ledger, by way of concrete example, one of the most mature prior art methods available to date is the PQIPs program provided through a healthcare payer in California. This program presents physicians with their performance using composite measures (a sum total of a series of other quality measures) across four categories which include: Preventative Care, Care Management, Generic Prescribing, and Administrative. Once each year, the physician is provided with a scorecard of their measures and providers who perform well and exceed the standards as set by the organization, are rewarded through additional payments, while those who fall below the standard are left unrewarded.

For those providers wishing to improve their scorecard results, the best that this prior art system can provide is a hyperlink to general information websites where the provider is on their own to search through volumes of static content to identify the nugget necessary to reverse their shortcomings. The gap between quality and performance measurement and quality and performance improvement highlighted by the above scenario, including the inability to connect providers with the right information at the right time, provides a looking glass into the underlying quality crisis in healthcare and the difficulty in fixing the crisis given current thinking.

As exemplified above, there has been a long-standing need for scalable systems and methods that provide for the longitudinal measurement and monitoring of quality and performance, coupled to organized curriculum that address individual provider needs as learners, or as administrators of learner organizations, to improve performance and quality. Further, such a system would allow organizations to track the utilization of interventional activities and the overall impact of specific interventions on the performance of their members, while standardizing the distribution of evidence-based guidelines and best care practices rapidly across the organization, to improve the quality, safety, and efficacy of care. Such a system would enable the provider to have the right information, for the right patient, to do the right thing, at the right time. The present invention addresses these needs.

### SUMMARY OF THE INVENTION

In accordance with at least one preferred embodiment, the present invention provides systems and methods for the improvement of professional performance. The present invention allows for the real time continuous measurement of the performance of professionals and allows that performance to be self-evaluated against pre-established, evolving and personal goals, benchmarks, and standards. Based upon the analysis of the professional's performance, the present invention includes systems and methods that determine and recommend individually tailored performance improvement interventional pathways that are designed to address specific deficiencies and the gaps in the individual professional's, or their healthcare systems' (e.g., practice, hospital, clinic, etc.), performance. The present systems and methods also allow professionals and administrators to evaluate the change in performance improvement over time, track and maintain accreditation and professional qualifications, and assess the real impact on performance based upon how interventions are sequenced within a performance improvement pathway. The present systems and methods allow educators and administrators to create dynamic performance improvement pathways using workflow (“if/then”) concepts in a web-based interface, which can be distributed to the professional learner, and also allow for the broad distribution of such performance improvement modules across multiple access portals.

The present invention is useful within the context of numerous educational (e.g. performance improvement for both teachers and students at multiple levels K-12, college, etc.) and professional disciplines including the medical, legal, law enforcement, public safety, and software engineering professions, or anywhere where measures can be identified, data collected, and interventions (including education and other interventional tools) applied. In particularly preferred embodiments, the present system is employed within the context of the medical profession.

The present invention provides systems and methods for continuous monitoring and improvement of performance of a user through performing multiple steps, including establishing measures of performance of the user, establishing targets for the performance of a entity, obtaining data about the performance of the entity and analyzing the data to identify deficiencies in performance of the user, wherein the analyzing includes comparing said performance against the targets, further wherein said analyzing is performed in real time and longitudinally over time. The methods and systems of the present invention may also employ or implement the steps of determining at least one performance improvement pathway for the user based on the identified deficiencies, which will then be provided to the user. The performance improvement pathway is preferably tailored to the user and their specific set of competencies and deficiencies. The present invention may further include reanalyzing the performance to confirm improvement of the performance. The user may also compare their performance against their peers. The present invention may also include an electronic portfolio module which may be used to provide information regarding the user's requirements including certification, licensure, or credentials in light of the performance improvement pathways.

The methods and systems of the present invention may employ data from multiple sources, such as electronic medical records, insurance claims, and patient outcomes and that obtaining may occur via automated data importation, manual data mapping and importation, or manual data entry. In certain presently preferred embodiments, the present invention obtains that data continually and uses it to perform and update the analysis in real time. In certain preferred embodiments, the analysis is performed automatically and across the course of the user's career.

The users of the present invention may include both organizational entities or individuals and the present invention has applicability across a wide variety of contexts including, but not limited to, the medical, legal, healthcare administration, educational, and emergency medical professions. The targets for performance may include goals that are set by an organizational entity or by an individual user, industry standards, or benchmarks against peers.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 depicts a high-level dashboard module of the present invention;

FIG. 2 shows a tool of the present invention that may be used to associate data fields with a measure;

FIG. 3 displays a mechanism by which a user may enter data into the systems of the present invention;

FIG. 4 shows a continuous performance monitor module of the present invention;

FIG. 5 depicts a detail of the practice profile and quality measure profile module of the present invention;

FIG. 6 shows an analysis tool of the present invention;

FIG. 7 displays an embodiment of a performance improvement pathway module of the present invention;

FIG. 8 depicts another embodiment of a performance improvement pathway module of the present invention;

FIG. 9 shows an ePortfolio module of the present invention; and

FIG. 10 depicts a performance improvement module and pathway builder tool of the present invention.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. The detailed description will be provided hereinbelow with reference to the attached drawings.

The present invention provides a platform for continuous quality and performance improvement for organizational entities (“entities”) and individuals, including professionals (“individuals”). The present invention encompasses systems that enable an entity to continuously measure and assess performance, deliver and track interventional activities, and assess ongoing performance improvement of entities and individuals, in real time. Through the present invention, an entity or individual may easily and cost-effectively define measures of quality or performance (“performance”), establish performance standards or goals (“standards”), as well as metrics for assessing outcomes, so as to be able to identify gaps in performance, including competency, knowledge, quality, cost, and efficiency, as well as overall results, respectively. By automatically linking recommended performance improvement pathways that may contain a variety of interventions (e.g., professional learning activities, consumer education tools, system-based change tools, self-assessment testing, etc.), and enabling such pathways to be automatically tailored based on the individual needs identified through the performance analysis process, the present invention allows entities to improve performance of participants in a continuous, scalable, disseminated, yet personalized manner. Furthermore, the present invention provides the individual with tools for tracking and assessing their performance longitudinally, including the ability to compare their performance against actions taken to improve, as well as a mechanism for managing, measuring, and gauging their industry-specific certifications, licensing, and qualifications.

In particular, the present invention centrally stores a library of performance improvement module (“PIM”) templates that serve as a virtual container for the various components (Measurement, Analysis, How to Improve?) that are necessary to measure, evaluate, and improve performance. PIMs contain performance improvement pathways (“PIPs”) that are driven by a workflow engine to create the personalized performance improvement process. The system includes administrative tools where both PIMs and related PIPs are designed, and where detailed and aggregate data resulting from user interaction with the system, is made available for reporting and outcomes measurement. The system also includes modules that allow industry specific tracking of certifications, and other metrics that characterize the overall performance of entities or individuals, including the reporting of activities between modules (e.g., activities completed within a performance module are reported in the ePortfolio module), and the ability to generate an overall performance and certification alert and action plan across modules. The specific metrics that are assessed will vary by industry and profession, and will be identified easily by those of ordinary skill in the art. Using defined performance objectives, the present invention allows an entity to propose the broad deployment of PIMs, which can be further customized by entities to improve performance. The present invention is preferably scalable so that the system may be implemented by a variety of entities, across disparate organizations, as well as within various disciplines. While providing for individually tailored improvement plans, the present invention at the same time allows an entity to evaluate best practices, outcomes, and interventional activities using organization- or industry-wide standards uniformly across the entire entity.

While the present invention will be routinely described herein within the context of the medical profession, it is to be understood that the present invention has general applicability to any entity or individual (including students, professionals, etc.) where it is advantageous to monitor and improve the performance of the entity or of its individuals. For example, the present invention is useful within the legal, education, and software engineering professions, to name only a few industries.

The present invention may be employed by a wide variety of entities and individuals. Within the context of the present description, the term “entity” means any company, school, hospital, health plan, managed care organization, partnership, practice, etc. in which individuals are performing (e.g., performing tasks, creating products, or delivering services) that need to be maintained to a particular standard. In order to assess and improve that performance, the present invention will preferably be used by officers or managers of that entity who will preferentially be referred to as “administrators” herein. The present invention may also be utilized by individuals who are seeking to improve their own performance. Such individuals include teachers, doctors, lawyers, engineers, police officers, fire officials, or any other professional or employee. In other embodiments, the present invention may be employed to evaluate the performance of students, teachers, or schools, in an academic setting and educating to the gaps in performance. In still further embodiments, the present invention may be employed to evaluate the performance of a business entity such as a medical practice (e.g., measuring quality indicators for process change, in programs with attached performance payments) or hospitals (e.g., hospital acquired infection control programs, with data collection for surveillance, with measurement linked to performance improvement pathways). In yet still further embodiments, the present invention may be employed for the consumer (e.g., patient in the medical scenario), to allow ongoing data collection, measurement, and analysis with linked interventions. Within the present description, all of those entities, individuals, or consumers are encompassed within the term “user”.

Initially, the present invention will be described in general terms in which particular aspects of the present invention will be highlighted. Following that broad description, specific examples will be detailed that emphasize the manner in which the invention may be implemented.

The present invention is conceptually driven by the well-known SIX SIGMA set of practices. The SIX SIGMA system, developed in the 1980s at Motorola, was designed to reduce variations in process output and performance as a way of improving business success. The SIX SIGMA system includes the following five steps: define, measure, analyze, improve, and control. The initial step in the process is to define the performance goals that are consistent with both customer demand and industry specifications. Secondly, one should measure the current process and activities by collecting relevant data for future comparison. Those data should be analyzed to verify the relationship between performance and outcomes and to determine where gaps in efficiency and performance are found. To address those deficiencies, improvements are designed based on the measured data. Finally, the improvement processes should be controlled or verified to ensure that improvement does indeed occur and that the relationship between performance and proposed improvement pathways is maintained.

The SIX SIGMA system was initially designed for industrial processes. Its implementation in professional settings is complicated by the complex realities found in those technical fields. For example, the wide variety of circumstances that may be encountered by a medical doctor in the clinic preclude canned or formulaic performance improvement pathways. The present invention addresses the higher complexity found in professional contexts by providing a highly customizable and longitudinal performance monitoring and improvement system.

The present invention accomplishes the above-stated goals by implementing a “Perpetual Performance Improvement” (“PPI”) system that provides users with access to lifetime performance improvement and learning management at a personal account level. By longitudinally measuring and analyzing a user's performance interlinked with prescriptive performance improvement pathways that are mobilized based on the performance relative to quality standards, benchmarks, or goals, the present invention creates a transparent cycle of improvement and enables lifetime learning for the user. The present invention is preferably web-based allowing both users and administrators within the entity to access and update information on demand, and broadly disseminate consistent information rapidly in real time. Since data used for measurement are collected, preferably in a continuous and automated fashion, and content is presented in real time, the present invention provides a mechanism for continuous improvement of performance. The present invention preferably further takes advantage of web-based technology to allow individual users to input and review data regarding their practices, receive comparative feedback, and access performance improvement pathways in real time.

By mapping critical steps in the planning process, the present invention provides the art with a project management tool that allows PIMs to be templated, standardized, and disseminated to all users, or customized for special projects, entities, or individuals. The administrator of the entity may select PIMs for use by its users, which they have created via the tools, or that have been created by a third-party organization. PIMs, particularly those developed by third parties, can be customized to address the specific interventions and/or goals required by an entity. The administrator and/or user can establish goals for performance, outcomes, certifications, or other standards. In certain preferred embodiments, goals are based on a needs-based assessment wherein the organization identifies the areas of a workforce's output that need to improve. Program outcomes can be linked to new needs-based assessments and measures, even within PIPs, to iteratively drive the learning cycle. The goals may be established at an organization-wide level, a practice area level within particular subsets of the organization, for specific individuals, or across organizations. While preset goals and plans may be developed in such a manner, the present invention is flexible in that it also allows for data-driven goals. For example, goals and plans for individual users may vary depending on their unique performance, deficiencies, or learning requirements (e.g., identified via self-assessment). Thus, the present invention provides for standardization across the entity as well as customization for individual users and projects.

Once a PIM is selected for an entity or user and the standards are established, the present invention preferably provides a mechanism for the collection of data and schedule for evaluating the data via the measures to assess the user's performance. Data regarding the user's practice may be obtained, as described below, including procedures routinely employed by the user. For example, the data may be input from self-assessment (testing) activities, prospective third party registries, retrospective data sets (e.g., medical, pharmacy and laboratory claims data), or via the systems internal registry, which is based on collecting data specifically to support the measures that have been defined within the PIM.

Based on the standards, users are alerted to situations in which (i) they have performed outside of the standard set for particular measures and (ii) when available, the granular data used to calculate the measure indicates that one or more items (e.g., patients, widgets, etc), are outside of the standard, even in those cases where the standard on the measure has been met by the user. The performance may be analyzed by the present system to provide automated evaluations and grading of performance to identify gaps in performance and points at which intervention may be required. The user is provided with tools for performing such self-analysis and “what-if” comparative analysis (e.g., compared to users in my specialty, region, etc.) to initiate self-awareness as part of the performance improvement process. Based upon rules tied to the results of the measures, the present invention provides the user with performance improvement pathways that are driven by such calculated measures. The system directs the user to a particular set of practice improvement pathways based on rules that may be defined by a human administrator and/or automatically generated rules, artificial intelligence, decision support, or industry standards. The present invention thus creates opportunity for customized and personalized prescriptive pathways for improvement based on standardized data, self assessment, past performance, and real life outcomes.

The present invention thereby provides the framework to advance the concept of improvement from the presentation of a single educational activity designed for all users based on a perceived needs assessment, or a simple notice to consider a single formulaic, discrete intervention (as in the prior art), to a multi-dimensional approach to performance improvement pathway conceptualization and creation as a workflow process, which is tied directly to performance measurement The workflow process within a PIP, supports linking one or more interventions of various types into a rules-based track. Tracks may be presented in singular fashion, as multi-track (e.g., parallel/concurrent) pathways, or as other workflow designs. Applying workflow concepts to performance improvement pathways by the present invention now enables open educational design, as well as time-based workflows using computer and human state engines.

The performance improvement pathways preferably include tools to enable visual pathway design and testing to allow administrators to construct pathways for performance improvement that contain one more interventions. Within the context of the present invention, such interventions may include direct links to industry-specific courses (e.g., CME classes), links to URLs, documents (via the system's internal document management system), evaluations, self-assessment examinations, and other available activities. Performance improvement programs may also include real time self-assessment wherein the user can see how their performance measures against industry standards or peer groups. The practitioner and organization may use the present invention to perform web utilization trending (both of the individual and of the entity), track participation in various performance initiatives, and to produce utilization reports. In that manner the present invention may provide a visual graphic display that presents the results of quality/performance measures longitudinally (i.e., over time) against an overlay of the interventions that were engaged in, in order to rapidly identify learning gaps, as well as ascertain the effectiveness of the intervention designed to close such gaps.

The present invention may also be used to maintain, monitor, and manage certifications, licensure, credentialing, and qualifications. In presently preferred embodiments, the present invention provides for the tracking of licensure periods and the identification of relevant classes for the individual practitioner to take to maintain licensure, credentialing, or certification. The present invention may also provide the organization and practitioner with alerts when licensing periods are nearing completion.

The concepts in the present invention, as set forth above, are implemented in the following manner in certain presently preferred embodiments. While the description of the present invention will be achieved through reference to screen captures generated by presently preferred embodiments, such descriptions are not meant to be limiting, but rather illustrative. One of ordinary skill in the art will recognize multiple manners in which the present invention may be implemented as variations on the examples provided below.

The present invention is preferably implemented as a comprehensive system that includes the numerous modules described herein to provide a total system for performance improvement and lifetime learning, which allows the user to track performance, identifies areas of weakness, and provides plans for improvement of performance to the user, combined with an electronic portfolio to track certifications, credentials and licensure, in order to embody the full convergence of quality improvement and personal lifetime learning. However, the system is preferably implemented in a modular fashion and provides value in various configurations, including, but not limited to; (i) a standalone registry system (e.g., web-based form capture of patient chart data) with or without reporting, (ii) automated data import and measurement reporting, (iii) automated data import and measurement reporting with analysis, (iv) standalone performance improvement system, (v) standalone electronic portfolio system, (vi) complete system. Additional modules may be included for specific access by administrators, data input, distribution of PIMs, or access by third parties as described hereinbelow.

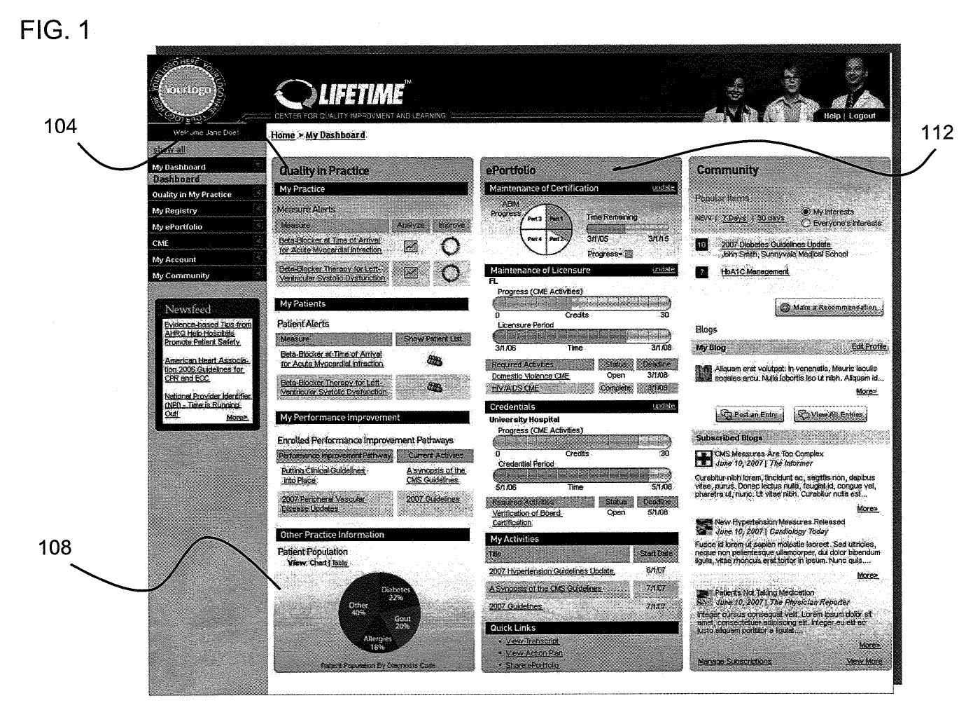

The present invention preferably includes an entity and/or user configurable dashboard system (FIG. 1) for users to interface with the various modules of the present invention. The dashboard module preferably provides the user with a composite of pertinent data, lists, and alerts relating to their practice and activities, organized by module. The dashboard module also provides the user with rapid access to underlying information, measures and other modules (e.g., electronic portfolio) of the present invention. The dashboard system is designed to constantly present key indicators of an entity's (e.g., when used to present data for a health system) or user's practice (e.g., what percentage of my patient population are diabetic) or practice performance, based upon multi-option data sources. The dashboard further allows users to view key indicators and alerts (e.g., measure alerts and item alerts (e.g., patients in the case of medical practitioners) that are generated by the present invention. Preferably, the dashboard provides data to the user that is specific to that individual's activities. The dashboard may also alert the user to specific deficiencies or problems that are currently present in their practice.

As shown in FIG. 1, the dashboard may include sections such as “Quality in Practice” 104 which includes details about the user's practice as detailed below. In the example shown in FIG. 1 those data include alerts, information, and the ability to link to details related to individual measures and individual patients, as well as overall demographic information about the user's practice 108. The dashboard may also provide access to other modules of the present invention, such as the registry module, community components, and the electronic portfolio module 112. The dashboard may also display recent activities undertaken either by the user or by others that involved the user. Messages from the system or administrators may also be displayed on the dashboard. Through the dashboard, the user may access any aspect of the present invention including action plans, registered PIPs, real time reporting, and analytics.

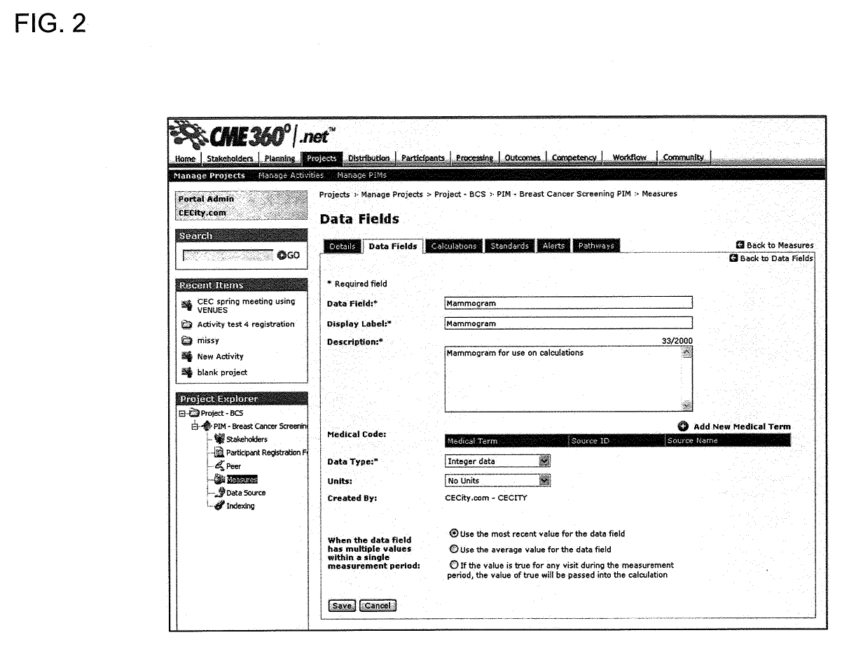

FIG. 2 represents a manner in which the present invention may be used to manage a project by associating data fields, calculations, and other information with a particular measure. Within the context of the present invention, a data field may be labeled and associated with a particular measure. The data field may further specify the data type and units, as well as assign the appropriate calculations and standards with that measure so that it may be analyzed appropriately. The measure may be further associated with specific alerts to be delivered to the user. The measure may also be tied to specific performance improvement pathways for which that measure is appropriate. In the example shown in FIG. 2, the present invention may be used to establish the data field of “Mammogram” as an integer-based measure which may be associated with breast cancer diagnosis standards, as well as pathways for improving the diagnosis and treatment of breast cancer.

The data to be analyzed by the present system may be obtained from a variety of sources. Preferably, several continuous data feeds are provided to the systems of the present invention so that up-to-date information regarding the user's practice and performance is employed in measurement and analysis. The system also allows for many forms of data input, including web-based forms for manual data entry and delimited file imports to enable the collection of necessary data.

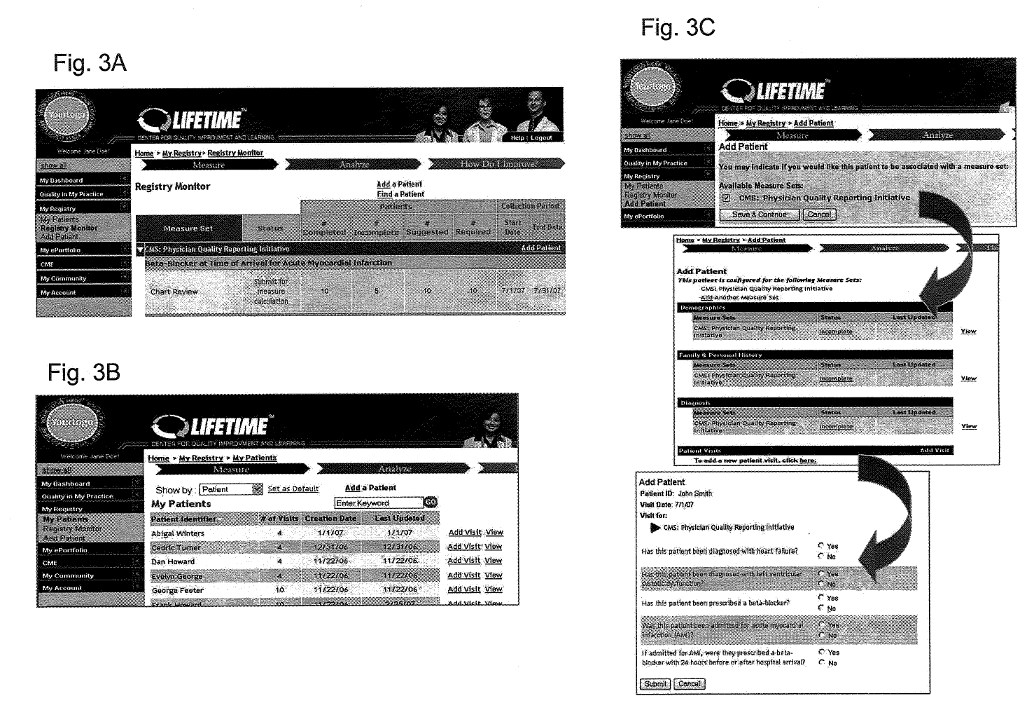

In some embodiments, once a measure has been established for a user, a registry within the system may be established whereby the present invention provides the user with a web-based form to effectively collect data specific to the measure as shown in FIG. 3. The user may monitor their registry to obtain information about specific items (e.g., patients) (FIG. 3A), including what measures are associated with that patient. In embodiments where the present invention is used in the medical area, entities and users may use the registry tool for many purposes, including collecting data for their own internal purposes, to compare the result of their data collection efforts against external data sets, or even to provide reports of such data to external third parties under performance programs. In embodiments where the present invention is used in the medical area, electronic medical records may be used as a source of information about patients, their treatments, and their outcomes. Third parties may also submit information in the forms of insurance claims, laboratory testing data, and pharmacy records. The present invention thereby builds “mapping” conduits between available electronic sources of data to bring such data into the present inventions data warehouse, where it can be stored until required by a measure for calculation.

For a particular PIM, multiple data sources can be defined, even within the same entity's implementation of the system, to allow monitoring and comparison across data sources. Furthermore, data can be provided to the system at various levels of detail, including at the aggregate level (e.g., aggregate data from the user's practice), at the item level (e.g., lab results for each patient related to each user), and pre-calculated, where the results of a standardized measure has been pre-calculated and a value is reported to the system. By providing the ability to automate the performance measurement process, through automated data importation, and by providing the ability to include data via web-based input forms, which include content that is automatically determined by the system specifically to address the pre-determined measure requirements, the present invention allows the user to initiate the performance improvement process in an improved manner over the prior art.

The user may also manage items in their registry (e.g., patients and review recent or upcoming visits) (FIG. 3B). The user may also add an item to their registry by entering specific data regarding that item (e.g., patient's care) (FIG. 3C). The user may also select which measures to couple to that item (e.g., patient).

The present invention may also employ data obtained from self-assessment by the user to characterize their competencies. For example, the user may take tests that assess their competency in a particular knowledge area. The scores on such tests may be used as described below to assess the user's competencies and deficiencies.

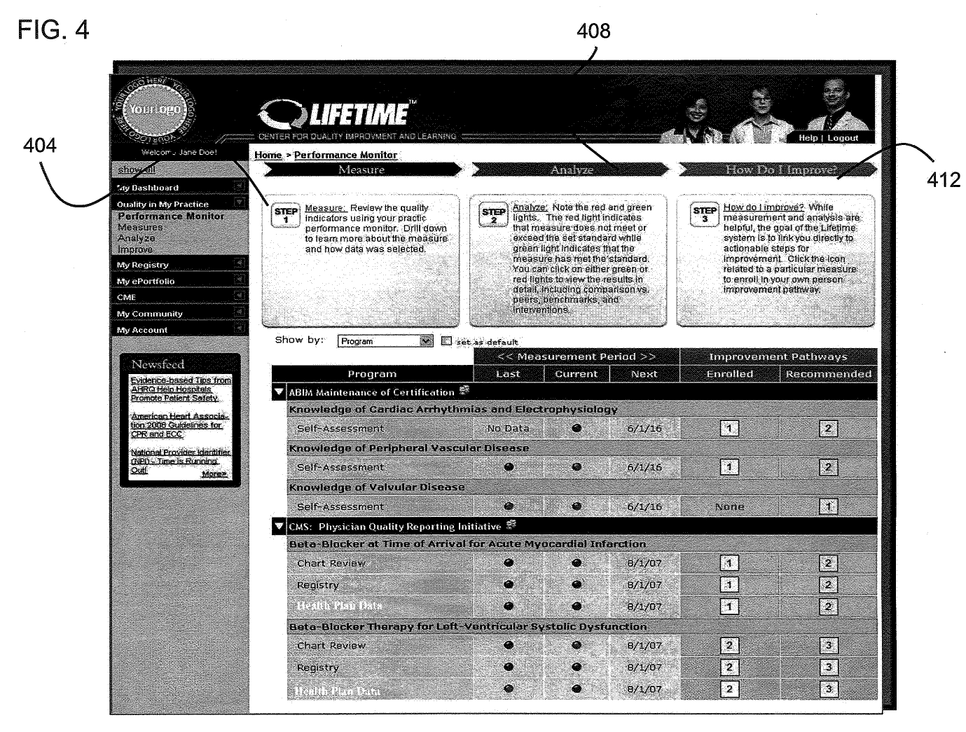

Preferably, all of the information about the user, their practice, and performance is presented by the present invention via the practice performance module. The present invention also preferably includes a practice performance module which the user may access by clicking on the configurable “Quality in My Practice” heading. Within the context of the present invention, the user is provided with a Performance Monitor webpage such as that shown in FIG. 4. A Performance Monitor page of the present invention provides the user with three categories of information directed toward performance improvement—Measure 404, Analyze 408, and How do I Improve? 412. These three areas provide the user with an easy to use, step-by-step approach to performance improvement. This monitor allows measures to be organized and categorized by category, type, program (e.g., a “pay for performance” program), etc. The user may drill down into each category to obtain additional information, as presented below.

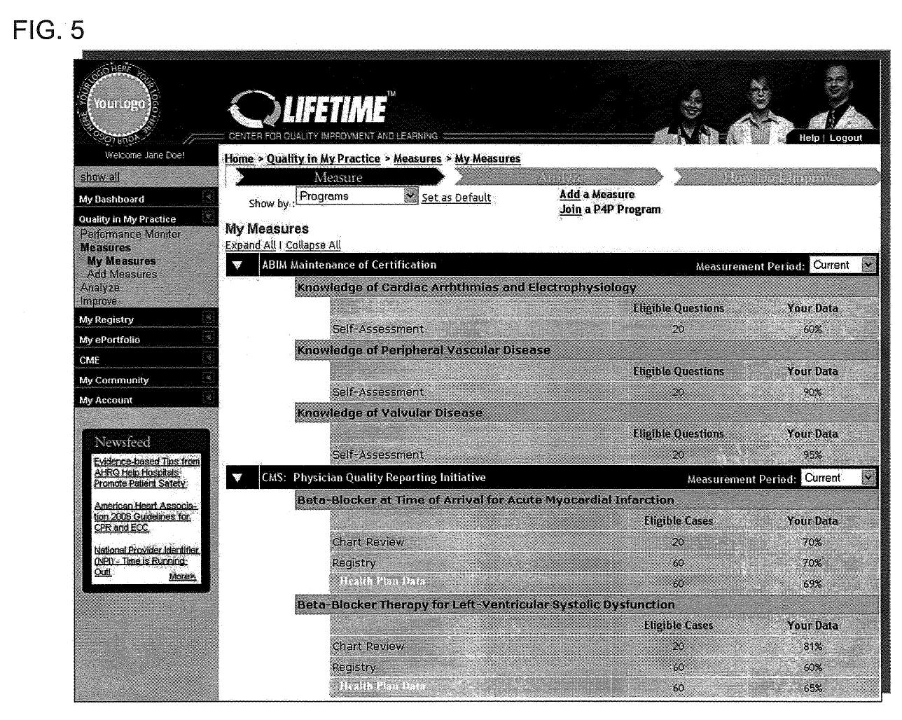

Under Measure (FIG. 5) the present invention allows the user to review the quality indicators that are being used to assess their practice or to select their own measures to track and manage from a standard library of measures. The user may obtain additional information about each measure and learn why that measure was selected for evaluation. The user is also presented with the relevancy of that measure to their practice. The user may also obtain information about their score for each measure by measurement period. The user may drill down into the score for each measure such as shown in FIG. 5 to analyze the results.

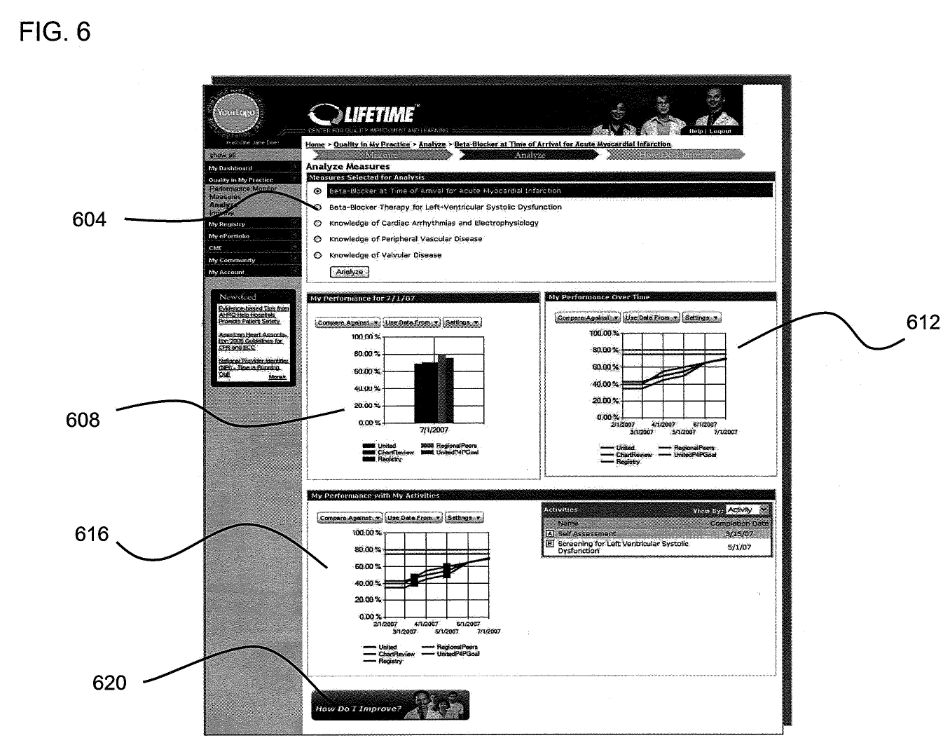

By selecting the Analyze option, or accessing the analysis detail from the various monitors, the user is provided with a webpage such as shown in FIG. 6. The Analyze portion of the practice profile module allows the user to critically evaluate their practice by analyzing the data associated with any measure 604. By selecting a measure, the professional may view their performance over time for that measure. The professional may compare their performance to that of their peers, to benchmarks, and to goals for a particular period 608. The professional may further evaluate their performance over time 612.

In particularly preferred embodiments, the professional may also graphically overlay their performance with performance improvement interventions 616. In that manner, the present invention allows the professional to assess the impact that various performance improvement pathways, and related interventions, have on their performance. By providing such information, the present invention allows the user to assess their progress in an improved manner over the prior art. Finally, the professional may also select a link entitled “How do I Improve?” 620 which will provide them with specific performance improvement pathways as described hereinbelow.

The output of the analysis shown in FIG. 6 is employed by the present invention to identify specific performance improvement pathways for the individual user. The specific personal interventions, improvement pathways, and resultant action plans are determined by an analysis of the performance of the user and are tailored to improve the deficiencies and gaps in performance for that individual user. The measures for the individual user are evaluated using a rule that is established by administrators with regards to goals, benchmarks, or standards. In the case of self-assessment, the rule may simply be used to assess the user's score on a particular test, or an answer to a particular question. In other instances, the rule may evaluate an item (e.g., patient) outcomes data to determine whether the user is maintaining certain standards (e.g., of patient care). In certain contemplated embodiments, the rule employs “fuzzy logic” to determine on a broader level whether a medical professional, for example, is employing the correct procedures in treating their patients. Regardless of the specific rules that are employed, the present invention preferably employs rule-based and role-based (e.g., nurse vs. physician) calculations to assess user performance and drive the linkage to PIPs. Specific deficiencies, gaps, or inefficiencies in performance are identified in instances where the user's measures do not meet the set standard. By providing direct linkage, between gaps and evidence-based PIPs that are designed to close the specific performance gaps, the present invention allows the user to quickly and precisely improve their performance progress in an improved manner over the prior art.

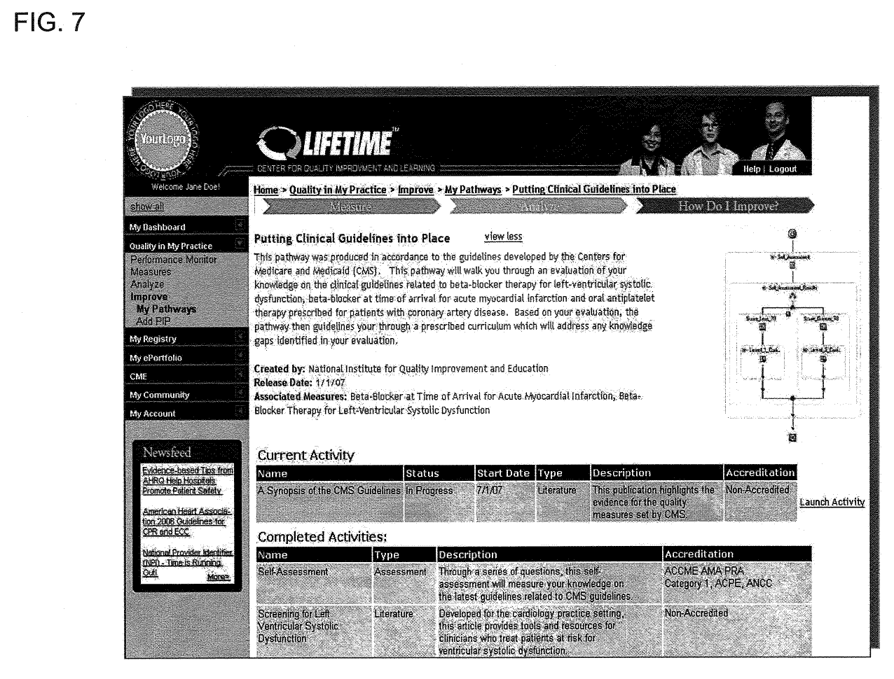

Within the context of a performance improvement module (PIM), the present invention provides performance improvement pathways (PIPs) to the user to rectify those deficiencies. FIG. 7 provides a specific example of the implementation of a performance improvement pathway. At various web pages of the present invention, the user is able to access the How do I improve? link which provides a webpage such as that shown in FIG. 7. The performance improvement pathway page provides the user with a sequence of interventional activities, which are presented as single activities, or as a list of activities (2 or more). The presentation and order of appearance of the interventions is based upon the administrator's educational design of the PIP template combined with the specific rules that have been included within a PIP to dynamically direct a particular user down one or more specific branches within the pathway. The performance improvement module also preferably shows activities in progress and completed activities. The user may drill down into the PIPs to obtain further information about each as shown in FIG. 7. The user may also add additional activities to the pathway that they feel will assist them in their performance improvement.

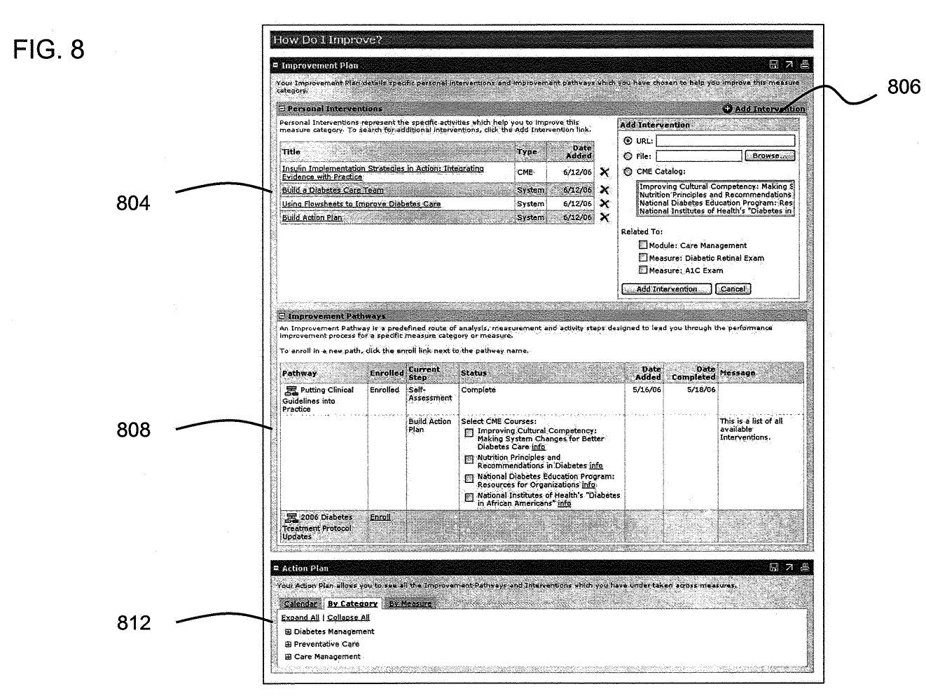

Performance improvement pathways may also be displayed in the performance improvement module as shown in FIG. 8. In certain presently preferred embodiments, performance improvement pathways include a visual system that allows for the construction of pathways for performance improvement that contain one or more interventions (e.g., CME activities, practice guidelines, systems-based interventions, technology-based interventions, etc.) integrated with a reporting and outcomes measurement system that collects and stores the details of each users interaction with the PIP workflow. Similar to as above for a user, such a feature allows administrators to compare the change in performance of a group of users, versus the intervention, to enable validation and/or modification of the performance improvement pathway and its contents to maximize the impact.

In the example shown in FIG. 8, the user is learning about how to improve their care management for treatment of diabetic patients. The present invention presents them with specific recommended steps to take along the performance pathway. The system also allows the medical practitioner to contribute performance improvement interventions 806 that they identify, such as a particularly useful article or patient practice relating to that measure. The performance improvement module includes the ability to develop an improvement plan that includes personal interventions defined by the user 804, system provided improvement pathways and related interventions 808, and the creation of an action plan to help the user track, manage, and plan their performance progress across all PIPs and personal interventions for which they have registered 812.

A system-provided PIP for example, may be titled “Putting clinical guidelines into practice,” which begins with an online, web-based self-assessment examination. Once completed, the user might be directed down one pathway branch or another depending on their responses to individual questions. The present system may address any errors through education (e.g., an online CME activity) or may direct the user to download a brochure that might help them address their practice administrative staff regarding proper management of diabetic patient scheduling (systems-based changes). By providing a dynamic workflow system to present and/or sequence interventional activities specifically to meet the needs of the individual, the present invention allows the user to more quickly and precisely improve their performance, in an improved manner over the prior art, while at the same time, remaining scalable to meet the needs of the entity.

The performance improvement module also summarizes an Action Plan 812 that may be viewed in multiple ways, including by category, measure, activity, and by calendar date. The action plan allows the user to see all of the improvement pathways for which they are registered and the activities requiring action. By providing such performance improvement planning information in an organized fashion, the present invention allows the user to assess and manage their progress in an improved manner over the prior art. The performance improvement module also provides the organizational entity with the ability to track the progress of individual users as they perform recommended activities and accomplish recommended goals, which in turn may be used to shape the materials, paths, and guidance that are presented to the user so that standards of practice are maintained across the entity in a continuous quality improvement fashion.

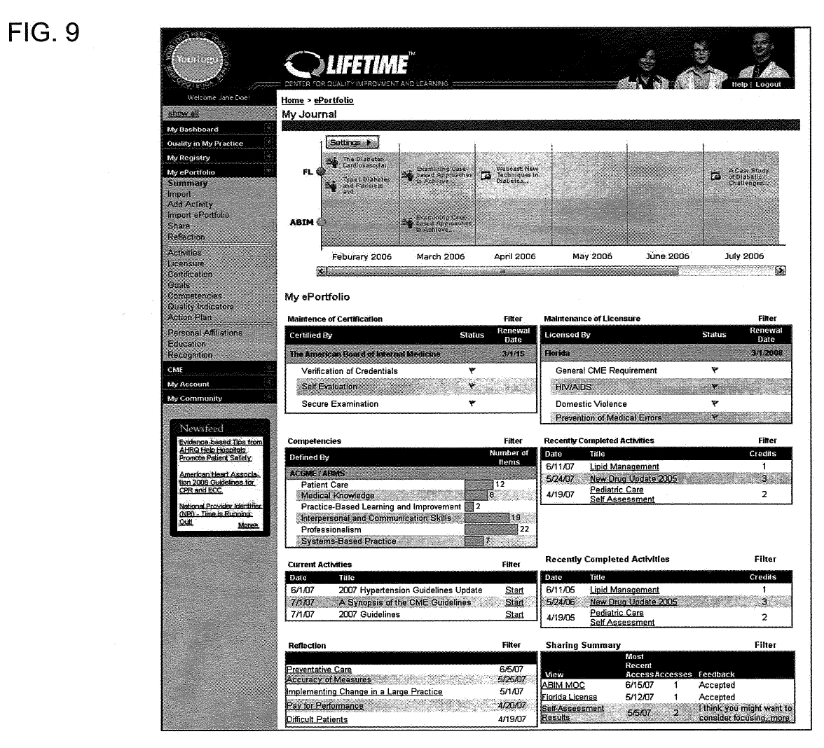

The present system may also include an electronic portfolio (“ePortfolio”) module as shown in FIG. 9. An ePortfolio, or online portfolio, module is centered on a concept that has been developed to support lifetime learning, including the tracking of credentials, licensure, certification, and materials related to the lifetime learning of the user (e.g., journal articles read, presentations delivered, etc.). The ePortfolio module also enables documented reflection, mentoring, and sharing, and can be used at all levels of education, including elementary, undergraduate, graduate, post-graduate, and ongoing continuing education.

While ePortfolio can be used as a valuable tool for the user standalone, the benefits of integrating with the performance improvement module, includes the convenient updating of requirements within ePortfolio as activities are completed during the performance improvement process (e.g., a PIM certified for 20 credits of ACCME CME credit and Maintenance of Certification Part IV credit for the American Board of Medical Specialties, are update in the Certification and Licensure components of the ePortfolio respectively, once completed in the performance improvement module) and includes creating a longitudinal connection between performance improvement and lifetime education. The ePortfolio module also preferably contains a calendar-based journal to provide planning, presentation of interventions tracked over time, and reflection. The ePortfolio journal provides the user with a manner of viewing all that needs to be done as part of their performance action plan chronologically, combined with the users' personal needs around lifetime learning and certification, all presented along. a visual timeline. ePortfolio also allows for the manual posting of activities completed through third parties. Users may also be able to elect to share all or a part of their ePortfolio with external persons (e.g., mentors or managers) or organizations (e.g., American Board of Internal Medicine) for certification credit.

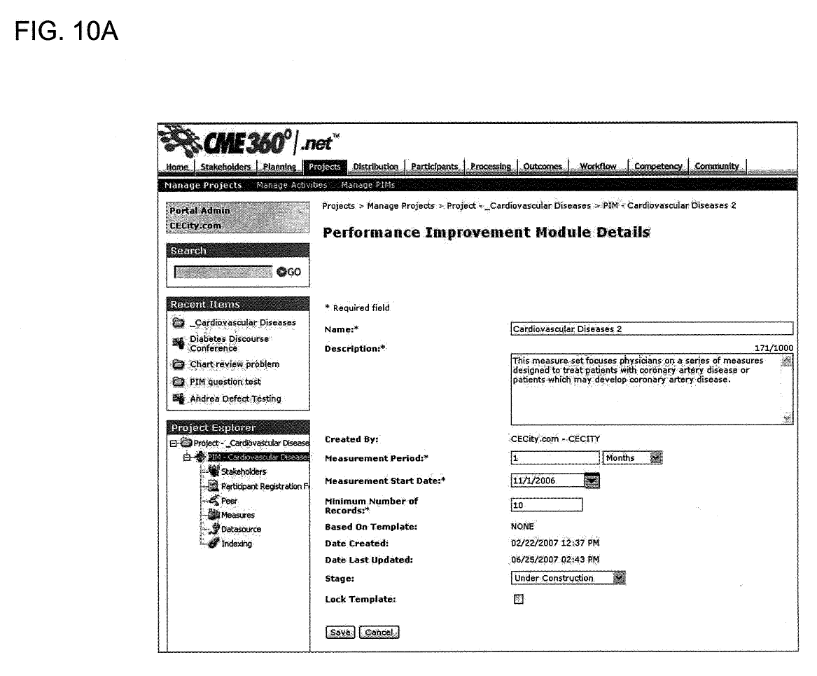

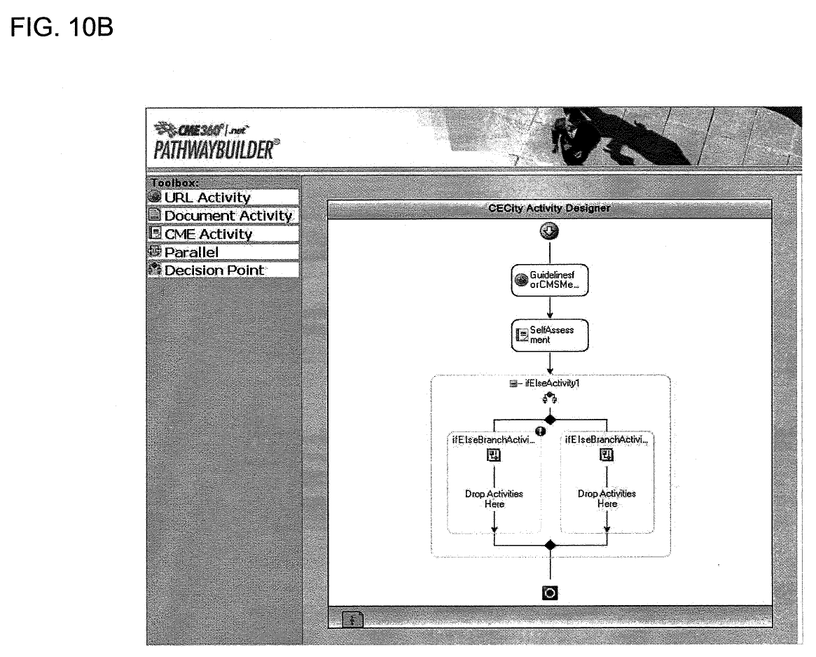

Administrators additionally have access to a project and content management module. The project and content management module allows the administrator to set and update PIMs, including measures, standards, PIPs and to assess overall and individual performance. The project and content management module supports an integrated planning process whereby PIMs are developed, and user performance goals and desired outcomes are coupled with performance improvement pathways. The present invention further provides a tool for PIPs that allows administrators to develop conditional performance improvement pathways as shown in FIG. 10B. The performance improvement pathways may be tied to particular distribution and credit scenarios, and various details can be established using text-based tools (e.g., number of records required before calculations are valid) (FIG. 10A).

The interventional activities that are to be presented to users within the improvement pathway may be graphically mapped to allow an administrator to construct a decision tree driven by explicit rules that determine the activities proposed to the user. This tool allows an administrator to build performance improvement pathways that may include single or multiple branches, and single or multiple decision points, where metrics, including the result of performance measures or a self-assessment completed within the PIP, can be evaluated to drive users down a personalized curriculum. The performance improvement pathway builder tool is built upon a standards-enabled workflow engine, which allows for dynamic behaviors, and organized step tracking and data capture. The performance improvement pathway builder tool further allows an administrator to customize existing PIP templates for their organization, and allows for dynamic behavior within the pathway to allow the user to jump to different levels or in different directions. The performance improvement pathway builder tool thus provides a level of flexibility to the administrator for the development, distribution, and delivery of individualized performance improvement pathways, in the present invention in an improved manner over the prior art.

The present invention is preferably developed as an integrated network that allows for a large number of separate branded portals to interface with users while at the same time remain connected to a central data warehouse for the purpose of reporting and outcomes. This network also preferably links to administrative tools to allow organizations that develop PIMs and PIPs to permit distribution of such PIMs and PIPs out to the various branded user portals. Exemplary libraries of PIMs and PIPs may be employed, particularly in the healthcare context including: performance improvement modules for diabetes management, infection control, preventative care, etc. By allowing key leaders in the art to distribute PIMs and PIPs out to end-users and disparate entities, the present system creates an opportunity to cost-effectively scale, uniformly disseminate, and translate best practices and performance improvement, with rapid resultant transformation, in an improved manner over the prior art.

In addition to the modules described hereinabove, the system may also preferably include several different modules including community modules that integrate with the other modules described herein. Other features, such as the ability to generate awards and/or certificates are additional options features that may be included in preferred embodiments of the present invention.

The operation of the present invention, as described above, are further elaborated within the context of the following example.

### EXAMPLE 1

A primary care medical practitioner (Dr. A) provides care to patients through a medical practice in which he is a partner. There are multiple offices within Dr. A's practice. The patients that Dr. A serves are primarily insured by the local Blue Cross entity, Plan X. Regardless of where Dr. A sees his patients, he is reimbursed for the services that he provides to these patients by Plan X, based upon medical claims that he submits. Detailed diagnosis, procedure, and some medical information are collected for such patients by Plan X, from Dr. A. In addition Plan X receives information from laboratory, pharmacy, and other services, for such patients, through various intermediaries. Certain types of information relevant to Dr. A's treatment of a patient, particularly clinical information, are not shared with Plan X through Dr. A or the intermediaries, and reside within Dr. A's charting system.

Plan X is committed to ensure that patients that it insures are provided with the highest quality of care possible and in order to keep health premiums at a minimum, desire to provide such care at a manageable cost. Plan X does not provide care directly to patients, instead that care is delivered through physicians and other service providers, an example of which is Dr. A. As part of Plan X's mission to improve quality for its customers, Plan X has aligned its quality improvement programs with concepts such as centralized care of patients (Patient Centered Medical Home) and shifting payment from a service based system towards payment based on quality. Plan X has identified a program to achieve its quality goals that includes providing incentives to Dr. A in the form of financial rewards based upon quality metrics, and which includes providing tools to help the physicians, and their practices rapidly improve their performance. Dr. A can qualify for certain financial rewards by achieving a standard of care, that is above goals set by Plan X, which are evaluated against various recognized quality measures. Plan X's incentive strategy is considered to be part of their Pay for Performance (“P4P”) program. Plan X decides to deploy this P4P program across their network of primary care physician providers. For their P4P program, Plan X has identified a highly visible public health issue that is to be a focus of their quality program, which affects a broad spectrum of covered patients: management of diabetic care. As a primary care physician, Dr. A sees a large number of diabetic patients, and therefore he has been identified as a candidate for participation in this program offered by Plan X.

As part of their P4P program, Plan X has selected the present invention to support the presentation of included measures, and to provide physicians and their practice with a platform for performance improvement. To prepare for the rollout of the P4P program, Plan X decides to use a PIM developed by the National Diabetes Foundation (NDF). Prior to Plan X using the system, the National Diabetes Foundation had developed a PIM that includes standardized performance measures for diabetic care, national benchmarks for the measures, and a related performance improvement pathway (“PIP”) that includes evidence-based guidelines and other recommended activities for improving performance in the management of patients with diabetes. This PIP includes a self assessment, online CME activities, practice guidelines, patient education material, systems-based recommendations for the provider care team, and other interventions that are currently being advocated by healthcare industry sources in the form of various courses and practices.

After selecting the PIM designed by the NDF, Plan X establishes their own goals for providers participating in the P4P program, which override those set by the NDF and incorporates additional benchmarks for physician performance, based on the regional data that they have collected. Plan X creates an overall composite measure for diabetic care that includes several measures, such as patient lab data for HBA1C, Lipid panels, etc. Plan X establishes a target goal for their P4P program, for this composite diabetic care measure equal to 75%. Plan X also amends the NDF's PIP with several interventional activities of its own, including its drug formulary and evidence-based guidelines.

Plan X prepares the appropriate data files to automatically and continuously upload into the present invention, to satisfy the data required to calculate the diabetic care measures. Because the data that Plan X has access to are limited to data related to claims data there are additional data fields, related to clinical information, that Plan X is not able to provide for. For these data fields, Plan X configures a registry within the system, so that the additional data may be collected directly from the physician's office. This clinical visit data will be combined with the data provided directly by Plan X inside the system, to drive the measure calculations.

Once the PIM is configured, the plan enrolls its various physicians in this P4P program, including Dr. A.

Dr. A receives and email message that welcomes him to the P4P program. He clicks a link and is able to log into the present invention using a standard Internet web browser. Upon login, he is presented with a high level dashboard. The dashboard interface provides him with details regarding his practice, demographic information on his patients, patient alerts regarding patients who are outside of the standards provided for diabetic care, and measure alerts, for those measures for which he is below the standards configured by Plan X within the NDF's performance module for diabetic care. He clicks on the Measure Alert for Diabetic Care and he is transferred to a second page.

On that second page, Dr. A is provided with an analysis of his performance on the measure, as well as additional information regarding his treatment of diabetic patients. He is able to compare his performance to industry standards, to peer groups, and also within his sub-discipline of diabetic treatment. He is disappointed to find that his performance was scored at 65%, below the plan goal of 75% and well below his peer group of family physicians score of 80%. On the same page, Dr. A also notices a heading entitled “How do I improve?” He clicks on this page and Dr. A is taken to a page where several performance improvement pathways are recommended to help him improve his performance, and that of his office. Dr. A selects one of the PIP's and chooses to enroll in it.

The PIP begins by explaining the process of performance improvement for Dr. A. and begins with a brief ten question self-assessment on diabetic care that includes questions regarding his knowledge, as well as questions about how his patients are managed by his office staff, and the level of technology he uses within his practice. Next, after reviewing the options provided to him, Dr. A selects to take an online CME course on “Nutrition Principles and Recommendations in Diabetes” to close a knowledge gap that was identified through the self-assessment. The present system recognizes a gap in Dr. A's treatment protocols and suggests to him that he include regular diabetic retinal examinations for his patients, and further suggests that his office staff implement a reminder system to support this change. Dr. A. further resolves to change his practice to form diabetic support groups for his patients on the basis of recommendations from the performance improvement pathways module.

Three months after participating in the PIP, taking the online CME activity and altering his practice, Dr. A receives an email notice that the diabetic care measures have been refreshed. He clicks the link in the email and after login to the site he notices that he no longer has an alert on this measure. He clicks down to his continuous practice performance monitor and further notices a green light on the diabetic care measure, indicating that he is now within the standard for this measure. This means that in addition to the fact that his practice is now delivering better care, Dr. A is now eligible for additional payments under the P4P program. He clicks the green light to look at an analysis of his score compared to his peers and compared to industry standards and sees how it has improved. His patients are responding to the altered treatment regimens and their improvement is reflected in his performance as quantified by the present system. Dr. A routinely visits the pages of the present system and consistently receives new input from the present system regarding additional practices and educational efforts to undertake to maintain, control, and surpass his improved performance.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A method for continuous monitoring and improvement of performance of a user, comprising:
establishing measures of performance of said user;
establishing targets for the performance of said user;
obtaining data about the performance of said user;
associating said data with said measures; and
analyzing said data to identify deficiencies in performance of said user, wherein said analyzing includes comparing said performance against said targets, further wherein said analyzing is performed in real time.

2. The method of claim 1, further comprising:
determining at least one performance improvement pathway for said user based on said deficiencies; and
providing said at least one performance improvement pathway to said user.

3. The method of claim 2, further comprising reanalyzing performance of said user to confirm improvement of said performance.

4. The method of claim 1, wherein said obtaining occurs by automated data importation, manual data mapping and importation, or manual data entry.

5. The method of claim 1, wherein said obtaining step is performed continually.

6. The method of claim 1, wherein said analyzing step is performed continually.

7. The method of claim 1, wherein said target is selected from the group consisting of goals, industry standards, individual standards, and benchmarks.

8. The method of claim 1, wherein said user is an organizational entity or an individual.

9. The method of claim 8, wherein said entity is selected from the group consisting of company, school, hospital, health plan, managed care organization, partnership, medical societies, certification boards, and medical practice.

10. The method of claim 8, wherein said individual is selected from the group consisting of teacher, doctor or allied healthcare professionals, lawyer, engineer, police officer, fire official, student, and patient.

11. The method of claim 1, further comprising comparing said performance against peers of said user.

12. The method of claim 1, wherein said analyzing step is performed automatically.

13. The method of claim 12, wherein said analyzing step is performed using preset rules or artificial intelligence.

14. The method of claim 2, wherein said determining step is performed using preset rules or artificial intelligence.

15. The method of claim 2, wherein said method is continually performed longitudinally over time.

16. The method of claim 2, wherein said performance improvement pathway is automatically customized to said user and said deficiencies.

17. The method of claim 3, wherein said reanalyzing step includes graphically representing said performance over time versus activities undertaken by said user as part of said performance improvement pathway.

18. A system for continuous monitoring and improvement of performance of a user, comprising:
a means for obtaining data about the performance of said user;
a means for associating said data with a measure of said performance;
a means for analyzing said data to identify deficiencies in performance of said user, wherein said analyzing includes comparing said performance against targets for said performance, further wherein said analyzing is performed in real time;
a means for determining performance improvement pathways for said user based on said deficiencies; and
a means for providing said performance improvement pathways to said user.

19. The system of claim 18, further comprising a means for reanalyzing performance of said user to confirm improvement of said performance.

20. The system of claim 18, further comprising an electronic portfolio module, wherein said electronic portfolio module is adapted to provide information regarding said user's requirements including certification, licensure, or credentials in light of said performance improvement pathways.

21. A method of developing performance improvement pathways, comprising:
identifying measures that characterize performance of a user;
identifying targets for performance of said user;
identifying decision points related to the measures to automatically determine the presentation of one or more performance improvement pathways;
identifying a set of interventions that contribute to improving said performance; and
using a workflow engine to sequence said interventions, and assign said interventions decision points to create one or more dynamic pathways for performance improvement.
